(19) United States
(12) Patent Application Publication
(10) Pub. No.: US 2010/0010661 A1
(43) Pub. Date: Jan. 14, 2010

(54) METHOD TO CONTROL AUTOMATIC POURING OF MOLTEN METAL BY A LADLE AND MEDIA FOR RECORDING PROGRAMS FOR CONTROLLING THE TILTING OF A LADLE

(75) Inventors: Kazuhiko Terashima, Aichi-ken (JP); Yoshiyuki Noda, Aichi-ken (JP); Kazuhiro Ota, Aichi-ken (JP); Makio Suzuki, Aichi-ken (JP); Junichi Iwasaki, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SINTOKOGIO, LTD., AICHI (JP)

(21) Appl. No.: 12/296,697

(22) PCT Filed: Apr. 6, 2007
(86) PCT No.: PCT/JP2007/057757

§ 371 Date: Sep. 23, 2009

(30) Foreign Application Priority Data
Apr. 14, 2006 (JP) 2006-111883

(51) Int. Cl. G06F 19/00

(52) U.S. Cl. 700/146

(57) ABSTRACT

The present invention provides a method to control automatic pouring of molten metal by a ladle that is tilted, wherein the pouring can be carried out in a way that is as close as possible to that of an experienced operator by using a computer that has programs previously installed for such purpose.

The method controls a servomotor, corresponding to the desired flow pattern of the molten metal, so that the molten metal can be poured into a mold, wherein the servomotor, which tilts the ladle to pour the molten metal in the mold, is controlled by a computer that has the programs previously installed to control the pouring. The method is characterized in that it comprises producing a mathematical model covering an electrical voltage that is supplied to the servomotor through the flow of the molten metal poured by the ladle, then obtaining the electrical voltage to be supplied to the servomotor by solving the inverse problem of the mathematical model thus produced, and controlling the servomotor based on the electrical voltage thus obtained and to be supplied to the servomotor.

### TECHNICAL FIELD

The present invention is directed to a method to control automatic pouring of the molten metal by a ladle and to media for recording programs for controlling the tilting of the ladle. More specifically, it is directed to a method of controlling a servomotor and to the media that record the programs for controlling the tilting of the ladle, so as to result in a molten metal being poured into a mold with the desired flow pattern, wherein the ladle is tilted by means of the servomotor, which is controlled by a computer that is programmed in advance to pour the molten metal.

Recently mechanizations and automatizations have been introduced in the process of pouring in foundries to relieve operators of extremely dangerous and severe work encountered in that process. Conventionally a system is adopted that comprises a ladle, a means to drive the ladle, a means to detect the weight of the ladle, and a recording and processing device that records in advance the ratio of the weight change in the ladle when the ladle is tilted, adjusts the speed of the tilting of the ladle corresponding to the signal received from the means to detect the weight, and after adjustment sends to the means to drive the ladle a signal on the speed of tilting the ladle (see Patent document 1).

(Patent document 1: Publication of Laid-open Patent Application No H6-7919)

### DETAILED DESCRIPTION OF THE INVENTION

### Problems to be Solved

However, the conventional automatic pouring system thus constituted has a problem, for example, in that the data input in the recording and processing device, of the information on, for example, the means to drive the ladle, is done practically by a teaching-and-playback method. Hence the system cannot cope with an inappropriate speed of titling the ladle or changes in the conditions of the pouring. As a result, for example, the castings become inferior in quality, because a sufficient quantity of molten metal is not poured into the mold, or impurities like dust, slag, etc., are disposed in the mold.

The present invention aims to solve the above-mentioned problems. The present invention provides a method to control the automatic pouring by a ladle, which is tilted to pour molten metal, and media that record programs for controlling the tilting of the ladle, wherein pouring can be performed in a manner that is as close as possible to that of an experienced operator by using a computer that has programs previously installed for such purpose.

### Means to Solve Problems

To achieve the object stated above, the method to control the automatic pouring by a ladle of the present invention is one that controls a servomotor, corresponding to the desired flow pattern of the molten metal, so that the molten metal can be poured into a mold, wherein the servomotor, which tilts the ladle to pour the molten metal in a mold, is controlled by a computer that has programs previously installed that control the process of pouring. The method is characterized in that it comprises producing a mathematical model covering an electrical voltage that is supplied to the servomotor through the flow of the molten metal poured by the ladle, then obtaining the electrical voltage to be supplied to the servomotor by solving the inverse problem of the mathematical model thus produced, and controlling the servomotor based on the electrical voltage thus obtained and to be supplied to the servomotor.

The method of the mathematical model that is used for the purpose of the present invention is a one which includes obtaining, by solving expressions relating to the thermal balance of a process, the balance of substances, chemical reactions, restricting conditions, etc., functions, such as profits, costs, etc., which are the objects to be controlled by the computer, and obtaining the maximum and minimum values of the functions and then controlling the process to attain them.

In the present invention, a ladle of a cylindrical shape that has a rectangular-shaped outflow position, or a ladle with the shape of a fan in its longitudinal cross section, which ladle has a rectangular-shaped outflow position is used. The ladle is supported at a position near to its center of gravity.

### The Effects of the Invention

As is clear from the foregoing explanations, the method of the present invention is directed to controlling the servomotor so that the molten metal can be poured in the mold from the ladle with the desired flow pattern of the molten metal, when the molten metal is poured into the mold from the ladle that is tilted by means of a servomotor that is controlled by a computer. The computer is previously installed with the programs that are to control the pouring process. The method comprises producing a mathematical model covering an electrical voltage that is supplied to the servomotor through the flow of the molten metal poured by the ladle, obtaining an electrical voltage to be supplied to the servomotor by solving the inverse problem of the mathematical model thus produced, and controlling the servomotor based on the electrical voltage to be supplied to the servomotor. Thus the method of the present invention has an advantageous effect such as that automatic pouring by the ladle can be carried out by the programs that are previously installed in a computer. Hence the pouring can be carried out in a manner that is as close as possible to that of an experienced operator.

### BEST MODE OF CARRYING OUT THE INVENTION

Below, based on FIGS. 1-14 an embodiment of the automatic pouring equipment to which the present invention is applied is explained in detail by the Examples.

As shown in FIG. 1, the automatic pouring equipment of the present invention comprises a ladle 1 with a cylindrical shape having a rectangular-shaped outflow position, a servomotor 2 that tilts this ladle 1, a transfer means 5 that transfers the ladle 1 and the servomotor 2 vertically and horizontally by means of two sets of ball screw mechanisms 3, 4 that convert a rotational movement of an axis of output of the servomotor to a linear movement, a load cell (not shown) that detects the weight of the molten metal in the ladle 1, and a control system 6 that calculates the movements of the servomotor 2 and of two sets of ball screw mechanisms 3, 4 and that also controls them by using a computer.

The axis of output of the servomotor 2 is connected at the center of gravity of the ladle 1. The ladle is supported at its center of gravity and can be tilted forward and backward around it in the direction toward and away from the sprue of the mold. Because the ladle can tilt around its center of gravity, the weight of the load on the servomotor 2 can be reduced.

To have the molten metal be precisely poured in the sprue of the mold, the transfer mechanism 5 operates in a manner in which it moves the ladle backward and forward and upward and downward in coordination with the tilting of the ladle, such that the end of the outflow position can act as a fixed center point for a virtual axis for turning.

The automatic pouring equipment thus constituted controls the tilting of the ladle 1 by means of a control system 6, corresponding to the electric voltage supplied to the servomotor 2. The electric voltage is obtained by solving the inverse problem of a mathematical model that is produced. The model shows the relationship between the tilting of the ladle that is caused by the electrical voltage supplied to the servomotor 2 and the flow of the molten metal to be poured from the ladle 1 by the tilting of the ladle.

That is, in FIG. 2, which shows a vertical cross-sectional view of the ladle 1 when it is pouring, given that θ (degree) is the angle of the tilting of the ladle 1, Vs (θ) (m³) is the volume of the molten metal (a darkly shaded region) below the line which runs horizontally through the outflow position, which is the center of tilting of the ladle 1, A (θ) (m²) is the horizontal area on the outflow position (the area bordering the horizontal area between the darkly shaded region and the lightly shaded region), Vr (m³) is the volume of the molten metal above the outflow position (the lightly shaded region), h (m) is the height of the molten metal above the outflow position, and q (m³/s) is the volume of the molten metal that flows from the ladle 1, then the expression that shows the balance of the molten metal in the ladle 1 from the time t (s) to the Δt after t (s) is given by the following expression (1):

expression (1)

Vᵣ(t)+Vₛ(θ(t))=Vᵣ(t+Δt)+Vₛ(θ(t+Δt))+q(t)Δt (1)

If the terms that have Vr (m³) in expression (1) are brought together and Δt is cause to be →0, the following expression (2) is obtained:

$${lim}_{Δ t \to 0} \frac{{V}_{r} ( t + Δ t ) - {V}_{r} ( t )}{Δ t} = \frac{d {V}_{r} ( t )}{d t} \\ = - q ( t ) - \frac{{aV}_{s} ( θ ( t ) )}{dt} \\ = - q ( t ) - \frac{\partial {V}_{s} ( θ ( t ) )}{\partial θ ( t )} \frac{d θ ( t )}{d t} \qquad ( 2 )$$

Also, the angular velocity of the tilting of the ladle 1, ω (degree/s), is defined by the following expression (3):

ω=dθ(t)/dt (3)

If expression (3) is substituted for the value in expression (2), then expression (4) is obtained.

$$\frac{d {V}_{r} ( t )}{d t} = - q ( t ) - \frac{\partial {V}_{s} ( θ ( t ) )}{\partial θ ( t )} ω ( t ) \qquad ( 4 )$$

The volume of the molten metal above the outflow position Vr (m³) is given by the following expression (5):

$${V}_{r} ( t ) = {\int }_{0}^{h ( t )} {A}_{s} ( θ ( t ) , {h}_{s} ) d {h}_{s} \qquad ( 5 )$$

Area Aₛ (m²) shows the horizontal area of the molten metal at height hₛ (m) above the horizontal area on the outflow position.

If area Aₛ (m²) is broken down into the horizontal area of the outflow position A (m²) and the amount of the change of area ΔAₛ (m²) over the area A (m²), then the volume Vr (m³) is given by the following expression (6):

$${V}_{r} ( t ) = {\int }_{0}^{h ( t )} ( A ( θ ( t ) ) + Δ {A}_{s} ( θ ( t ) , {h}_{s} ) ) d {h}_{s} \\ = A ( θ ( t ) ) h ( t ) + {\int }_{0}^{h ( t )} Δ {A}_{s} ( θ ( t ) , {h}_{s} ) d {h}_{s} \qquad ( 6 )$$

With ladles in general, including the ladle 1, because the amount of the change of area ΔAₛ (m²) is very small compared to the horizontal area on the outflow position A (m²), the following expression (7) is obtained:

$$A ( θ ( t ) ) h ( t ) >> {\int }_{0}^{h ( t )} Δ {A}_{s} ( θ ( t ) , {h}_{s} ) d {h}_{s} \qquad ( 7 )$$

Thus expression (6) can be shown as the following expression (8):

Vᵣ(t)≈A(θ(t))h(t) (8)

Then the following expression (9) is obtained from expression (8):

h(t)≈Vᵣ(t)/A(θ(t)) (9)

The flow of the molten metal q (m³/s) that flows from the ladle 1 at height h (m) above the outflow position is obtained from Bernouilli's theorem. It is given by the following expression (10):

$$q ( t ) = c {\int }_{0}^{h ( t )} ( {L}_{f} ( {h}_{b} ) \sqrt{2 {gh}_{b}} ) d {h}_{b} , ( 0 < c < 1 ) \qquad ( 10 )$$

wherein h_{b} (m) is, as shown in FIG. 4, the depth of the molten metal from its surface in the ladle 1, L_{f} (m) is the width of the outflow position at depth h_{b} (m) of the molten metal, c is a coefficient of the flow of the molten metal that flows out, and g is the gravitational acceleration.

Further, the following expressions (11) and (12), which show the basic model of the expression for the flow of the molten metal, are obtained from the expressions (4), (9) and (10):

$$\begin{matrix}\frac{d {V}_{r} ( t )}{d t} = - c {\int }_{0}^{\frac{{V}_{r} ( t )}{A ( θ ( t ) )}} ( {L}_{f} ( {h}_{b} ) \sqrt{2 {gh}_{b}} ) d {h}_{b} - \frac{\partial {V}_{s} ( θ ( t ) )}{\partial θ} ω ( t ) & ( 11 ) \\ q ( t ) = c {\int }_{0}^{\frac{{V}_{r} ( t )}{A ( θ ( t ) )}} ( {L}_{f } ( {h}_{b} ) \sqrt{2 {gh}_{b}} ) d {h}_{b} , ( 0 < c < 1 ) & ( 12 )\end{matrix}$$

Also, the width of the rectangular-shaped outflow position of the ladle 1, L_{f} (m), is constant relative to h_{b} (m), which is the depth from the surface of the molten metal in the ladle 1. Then the flow of the molten metal, q (m³/s), that flows from the ladle 1 is obtained from the expression (10) and given by the following expression (13):

$$q ( t ) = \frac{2}{3} {cL}_{f} \sqrt{2 g} {h ( t )}^{3 / 2} , ( 0 < c < 1 ) \qquad ( 13 )$$

This leads to the following: substitute the expression (13) for the values of each of the expressions (11) and (12), which show the basic model expressions for the flow of the molten metal, and then the following model expressions for the flow of the molten metal (14) and (15) are obtained:

$$\begin{matrix}\frac{d {V}_{r} ( t )}{d t} = - \frac{2 {cL}_{f} \sqrt{2 g}}{3 {A ( θ ( t ) )}^{3 / 2}} {{V}_{r} ( t )}^{3 / 2} - \frac{\partial {V}_{s} ( θ ( t ) )}{\partial θ} ω ( t ) & ( 14 ) \\ q ( t ) = \frac{2 {cL}_{f} \sqrt{2 g}}{3 {A ( θ ( t ) )}^{3 / 2}} {{V}_{r} ( t )}^{3 / 2} , ( 0 < c < 1 ) & ( 15 )\end{matrix}$$

The horizontal area on the outflow position, A (θ) (m²), changes depending on the angle of the tilting of the ladle 1, (θ) (degrees). Thus the model expressions (14) and (15) for the flow of the molten metal will be non-linear models. Their parameters are variable depending on how the system matrix, input matrix, and output matrix vary based on the angle of the tilting of the ladle 1.

An experiment was carried out using the automatic pouring equipment of the present invention, so as to identify the coefficient of the flow of the molten metal, and to examine the effectiveness of the models proposed herein, wherein water is used for the molten metal.

FIG. 5 is a block diagram that shows the process of the pouring by the automatic pouring equipment of the present invention. In FIG. 5 Pm denotes a motor. A model for the revolutions of the motor is shown by the following expression (21) of the first order lag:

dω(t)/dt=−ω(t)/Tₘ+Kₘu(t)/Tₘ (21),

wherein Tm (s) denotes a time constant and Km (deg/s V) denotes a gain constant. In the present automatic pouring equipment, Tm=0.006 (s), and Km=24.58 (deg/s V).
Also, in FIG. 5, P_{f} shows a model expression for the flow of the liquid that flows from a ladle that has a rectangular-shaped outflow position, such as the model for the automatic pouring equipment of the present invention, given by the expressions (14) and (15). The volume of the liquid that flows out is calculated by integrating the volume of the liquid obtained from the model for the volume of the liquid that flows out. The weight of the liquid that flows out is obtained by multiplying K times the volume of the liquid that flows out. In the present experiment, water is used as a liquid. So, K is 1.0×10³ (Kg/m³).

If the dynamic characteristics of the load cell are considered, then P_{L} of the load cell is shown by the following expression (22)

dw_{L}/dt =−w_{L}(t)/T_{L}+w(t)/T_{L} (22),

wherein w (Kg) is the weight of the liquid that has flowed from the ladle 1, w_{L} (Kg) is the weight to be measured by the load cell, and T_{L} (s) is a time constant that shows the lag of the response of the load cell. In the present automatic pouring equipment, where the time constant was measured by a step response method, T_{L} was identified as T_{L}=0.10 (s).

Regarding model expressions (14) and (15) for the flow of the molten metal, FIG. 6 shows the horizontal area on the outflow position, A (θ) (m²), at the angle of the tilting of the ladle 1, θ (degrees), and the volume of the molten metal (liquid), Vs (θ)(m³), below the line which runs horizontally through the outflow position. In FIG. 6, (a) shows the horizontal area of the outflow position, A (θ) (m³), when the angle of the tilting of the ladle 1 is θ (degrees), (b) shows the volume of the molten metal (liquid), Vs (θ) (m³),below the line which runs horizontally through the outflow position, when the angle of the tilting of the ladle 1 is θ (degree).

To identify the coefficient c of the flow of the molten metal, pouring is carried out while the angular velocity of the tilting of the ladle 1, ω (degree/s), is kept constant. The weight of the liquid that flows from the ladle 1 and that is measured by the load cell in the experiment and the result obtained from the simulation using expressions (14) and (15) are compared. Then an appropriate coefficient is produced so as to have the weight and the result obtained from the simulation be consistent. As a result, the coefficient that is obtained is c=0.70.

The results of the experiment for identification are shown in FIG. 7. Also, to examine the effectiveness of the models, the experiments of the pouring were carried out with the initial angles of the tilting of the ladle being varied. The results are shown in FIG. 8.

The initial angle of tilting was 39.0 (degrees) at the start of the pouring in the experiment for identification. The results of the experiment are shown in FIG. 7. The initial angle of tilting was 44.0 (degrees) in the experiment for identification to examine the effectiveness of the models. The results of the experiment are shown in FIG. 8. In FIGS. 7 and 8, (a) shows the angular velocity of the tilting of the ladle 1, ω (degrees/s), in the simulation, (b) shows the angle of the tilting of the ladle 1, θ (degrees), in the simulation, (c) shows the volume of the liquid that flows from the ladle 1, q (m³/s), in the simulation, and (d) shows the weight of the liquid that flows from the ladle 1, w_{L} (Kg), in the simulation and experiments.

Also, in FIGS. 7(d) and 8(d), the solid line shows the weight of the liquid that flows from the ladle 1 in the pouring experiment. The dotted line shows the weight of the liquid that flows from the ladle 1 in the simulation. In both the experiment and the simulation the angular velocities of the tilting of the ladle are ω=0.17 (deg/s).

From the experiment and the simulation, it is seen that the model expression for the flow pattern of the molten metal of the present invention highly accurately reflects the flow of the molten metal.

Next, by using the model expression for the flow of the molten metal and thus obtained, a feed-forward control for the flow of the molten metal is constructed, based on its inverse model.

The feed-forward control is a control method wherein the output is controlled so that it becomes a target value, by adjusting to the predetermined values those values that will be added to the objects to be controlled. By this method a favorable control can be achieved if the relationships of the input to the output in the objects to be controlled or the effects of an exterior disorder are obvious.

FIG. 9 is a block diagram for a control system in a system wherein, so as to achieve the desired flow pattern of the molten metal, q_{ref} (m³/s), the input voltage for control of u (V) that is supplied to the servomotor 2 is obtained. The inverse model Pm⁻¹ of the servomotor 2 is shown by the following expression (23):

$$u ( t ) = \frac{{T}_{m}}{{K}_{m}} \frac{d {ω}_{ref} ( t )}{d t} + \frac{1}{{K}_{m}} {ω}_{ref} ( t ) \qquad ( 23 )$$

An inverse model of the basic model expression for the flow of the molten metal as shown in expressions (11) and (12) will be obtained. The flow of the molten metal, q (m³/s), which is the volume of the molten metal that flows at a height h (m) above the outflow position, can be obtained from the expression (10), which is Bernouilli's theorem. The maximum height, hₘₐₓ (m), is equally divided by n. Each divided height is denoted by Δh (m), wherein hₘₐₓ (m) is the height above the outflow position when from the shape of the ladle 1 the volume above the outflow position is considered as being the largest. Each height of the molten metal h, is shown as hᵢ=iΔh (i=0, . . . n). Thus the flow of the molten metal that flows, q=(q₀, q₁ . . . qₙ)^{T}, for the height, h=(h₀, h₁ . . . hₙ)^{T}, is shown by the following expression (24):

q=f(h) (24)

wherein function f(h) is Bernouilli's theorem as shown by the expression (10). Thus the inverse function of expression (24) is given by the following expression (25):

h=f⁻¹(q) (25)

This expression (25) can be obtained by inverting the relationship of the input and output factors in expression (24). (h) in expression (25) is obtained from the “Lookup Table.” Now, if qᵢ→qᵢ₊₁, and hᵢ→hᵢ₊₁ then the relationship can be expressed by a linear interpolation. If the width that is obtained after the height, hₘₐₓ (m), is divided is narrower, the more precisely can be expressed the relationship of the flow of the molten metal, q (m³/s), to the height h (m) above the outflow position. Thus it is desirable to make the width of the division as narrow as practically possible.

The height of molten metal above the outflow position, h_{ref} (m), which is to achieve the desired flow pattern of the molten metal, q_{ref} (m³/s), is obtained from the expression (25) and is shown by the following expression (26):

h_{ref}(t)=f⁻¹(q_{ref}(t)) (26)

Also, given that the height of the molten metal above the outflow position is h_{ref} (m), the volume of the molten metal above the outflow position, V_{ref} (m), is shown by the expression (26), which is obtained from the expression (25).

V_{ref}(t)=A((θ(t))h_{ref}(t) (27)

Next, if the volume of the molten metal above the outflow position, V_{ref} (m), as shown by the expression (27) and the desired flow pattern of the molten metal, q_{ref} (m³/s), are substituted for the values in the basic model expression (11) for the flow of the molten metal, then the following expression (28) is obtained. It shows the angular velocity of the tilting of the ladle 1, ω_{ref} (degree/s). This angular velocity is to achieve the desired flow pattern of the molten metal.

$${ω}_{ref} ( t ) = - \frac{\frac{d {V}_{rref} ( t )}{d t} + {q}_{ref} ( t )}{\frac{\partial {V}_{s} ( θ ( t ) )}{\partial θ ( t )}} \qquad ( 28 )$$

By solving in turn expressions (24) to (28) and substituting the angular velocity of the tilting of the ladle 1, w_{ref} (degree/s), which is obtained, for the values in the expression (23), so as to produce the desired flow pattern of the molten metal, q_{ref} (m³/s), the input voltage for control, u (V), which is to be supplied to the servomotor 2, can be obtained.

Also, the volume of the molten metal above the outflow position, V_{ref} (m), which is to achieve the desired flow pattern of the molten metal, q_{ref} (m³/s), is expressed by the following expression (29) by using the expression (15):

$${V}_{rref} ( t ) = \frac{3 A ( θ ( t ) )}{{( 2 {cL}_{f} \sqrt{2 g} )}^{2 / 3}} {{q}_{ref} ( t )}^{2 / 3} \qquad ( 29 )$$

Substitute both the volume of the molten metal above the outflow position, V_{ref} (m), which was obtained from expression (29), and the desired flow pattern of the molten metal, q_{ref} (m³/s), for the values in the expression (28). Then the angular velocity of the tilting of the ladle 1, w_{ref} (degree/s), which is to achieve the desired flow pattern of the molten metal, is obtained. Next, substitute the angular velocity of the tilting of the ladle 1, w_{ref} (degrees/s), that was obtained, for the value of the inverse model of the expression (23) for the servomotor 2. Then the input voltage for control, u (V), that is to be supplied to the servomotor 2 can be obtained.

FIG. 10 shows the results of a simulation when the control system of FIG. 9 is applied to the automatic pouring equipment of the present invention. In the present simulation the initial angle of the tilting of the ladle is set as θ=39.0 (degrees). In FIG. 10, (a) shows the desired flow pattern of the molten metal, q_{ref} (m³/s), (b) shows the angular velocity of the tilting of the ladle 1, ω_{ref} (degrees/s), which is obtained from expressions (28) and (29), and which is to achieve the desired flow pattern of the molten metal, and (c) shows the angle of the tilting of the ladle 1 angle θ. (d) shows the input voltage for control, u (V), which is supplied to the servomotor 2 and which is obtained by substituting the angular velocity of the tilting of the ladle 1, w_{ref} (degrees/s) for the value of the expression (23) which is the inverse model of the servomotor 2

The expression of the desired flow pattern of the molten metal, q_{ref} (m³/s), as shown by FIG. 10(a), is used to obtain the expression for the input voltage for control, u (V), through the inverse model of the expression for the flow of the molten metal, which includes the model for servomotor. Thus the expression of the desired flow pattern of the molten metal must be able to be differentiated twice.

To complete the pouring within a short time, it is necessary to promptly pour the molten metal so that it reaches a higher level of the sprue of the mold. For that purpose, initially the molten metal should be poured in a larger quantity. Then when the level of the molten metal rises in the sprue, the molten metal should be poured in a lesser quantity so that it does not drip from the sprue. By using the following expression (31) the desired flow pattern of the molten metal is obtained, so as to meet all these requirements.

$${q}_{ref} ( t ) = \{ \begin{matrix}\frac{{Q}_{r}}{2} ( 1 - cos ( \frac{π t}{{T}_{rise}} ) ) & ( 0 \leq t < {T}_{r} ) \\ {Q}_{st} + \frac{{Q}_{r} - {Q}_{st}}{2} ( 1 + cos ( \frac{π t}{{T}_{st} - {T}_{r}} ) ) & ( {T}_{r} \leq t < {T}_{st} ) \\ {Q}_{st} & ( t \geq {T}_{st} )\end{matrix} \qquad ( 31 )$$

wherein Tr (s) shows the time when the pouring of the molten metal starts, and Qr (m³/s) shows the flow of the molten metal (maximum flow) at the time Tr (s). Tₛₜ (s) shows the time from the start of the pouring of the molten metal until the flow becomes constant. The constant flow is given by Qst (m³/s).

Also, when the input voltage for control, u (V), of FIG. 10(d) is loaded on the servomotor 2, the desired flow pattern of the molten metal, q_{ref} (m³/s), is obtained.

The experiment of pouring is carried out using the automatic pouring equipment of the present invention, using the above mentioned system to control the flow of the molten metal. The evaluation of the pouring is made by measuring, by the load cell, the weight w_{L} (Kg) of the molten metal that flows from the ladle 1. Thus the weight of the molten metal that flows from the ladle 1 should be converted, based on the results of the measurements obtained by the load cell, such that it can be applied to the desired flow pattern of the molten metal, q_{ref} (m³/s).

FIG. 11 shows the results obtained from the desired flow pattern of the molten metal shown in FIG. 10(a) after the volume of the molten metal that flows out is converted to the weight and processed by the load cell model as shown in FIG. 5. Given that the desired flow pattern of the molten metal is as shown in FIG. 11, then, if the system to control the flow of the molten metal of the present invention is applied to the automatic pouring equipment of the present invention, the results of the experiments are obtained such as are shown in FIGS. 12 and 13.

In FIG. 12, the initial angle of the tilting of the ladle 1 is 39.0 (degrees) at the start of the pouring. In FIG. 13, the initial angle of the tilting of the ladle 1 is 44.0 (degrees) at the start of the pouring.

In FIGS. 12 and 13, (a) shows the input voltage for control, u (V), that is supplied to the servomotor 2, (b) shows the angular velocity of the tilting of the ladle, 1, ω (degree/s), (c) shows the angle of the tilting of the ladle 1, θ (degrees), and (d) shows the weight w (Kg), which is measured by the load cell, of the molten metal that flows from the ladle 1. The solid line shows the results obtained when the system to control the flow of the molten metal of the present invention is applied.

In FIGS. 12(d) and 13(d), the dashed line shows the weight of the molten metal that flowed from the ladle 1, when the desired flow pattern of the molten metal is converted by the load cell.

In the above embodiment the ladle 1 of a cylindrical shape having a rectangular-shaped outflow position is used. But as shown in FIG. 14, the ladle with the shape of a fan in its longitudinal cross section having a rectangular-shaped outflow position also produces a similar effect.

That is, given that in FIG. 14 the width of the outflow position is L_{f} (m), the width of the ladle body is L_{b} (m), the length of the outflow position is R_{f} (m) and the total length of the ladle is R_{b} (m), and because the horizontal area A (m²) on the outflow position is constant irrespective of the angle of the tilting of the ladle, θ (degree), then area A (m²) is expressed by the following expression (16):

A=R_{b}L_{b}−2R_{f}L_{f} (16)

Also, the volume of the molten metal below the outflow position Vs (m³) varies in proportion to the angle of the tilting of the ladle, θ (degrees). It is expressed by the following expression (17):

Vₛ(θ)=(L_{b}R_{b}²−(L_{b}−L_{f})R_{f}²)θ (17)

Thus the following partial derivative, DVₛ (18), is obtained from the volume of the molten metal below the outflow position, Vs (m³), by differentiating partially in respect to the angle of the tilting of the ladle, θ (degrees):

$$\frac{\partial {V}_{s} ( θ )}{\partial θ} = {DV}_{s} = {L}_{b} {R}_{b}^{2} - ( {L}_{b} - {L}_{f} ) {R}_{f}^{2} \qquad ( 18 )$$

From this expression it is seen that the partial derivative, DVₛ, is constant and that it does not depend on the angle of the tilting of the ladle, θ (degrees).

Also, in expression (12), which is the basic model expression of the flow of the molten metal, the width of the outflow position L_{f} (m) is constant relative to the depth, h_{b} (m), from the surface of the molten metal in the ladle. Thus the expression (12) is reduced to the expression (13). Substitute the expressions (16), (18) and (13) for each of the values in the basic model expressions (11) and (12) for the flow of the molten metal. Then the basic model expressions for the flow of the molten metal for the ladle with the shape of a fan are obtained. They are expressed by the following expressions (19) and (20):

$$\begin{matrix}\frac{d {V}_{r} ( t )}{d t} = - \frac{2 {cL}_{f} \sqrt{2 g}}{3 {A}^{3 / 2}} {{V}_{r} ( t )}^{3 / 2} - {DV}_{s} ω ( t ) & ( 19 ) \\ q ( t ) = \frac{2 {cL}_{f} \sqrt{2 g}}{3 {A}^{3 / 2}} {{V}_{r} ( t )}^{3 / 2} , ( 0 < c < 1 ) & ( 20 )\end{matrix}$$

Thus they are non-linear constant models, with their system matrix, input matrix, and output matrix, being constant.

The basic Japanese Patent Application, No. 2006-111883, filed Apr. 14, 2006, is hereby incorporated in its entirety by reference in the present application.

The present invention will become more fully understood from the detailed description of this specification. However, the detailed description and the specific embodiment illustrate desired embodiments of the present invention and are described only for the purpose of explanation. Various changes and modifications will be apparent to those of ordinary skilled in the art on the basis of the detailed description.

The applicant has no intention to dedicate to the public any disclosed embodiments. Among the disclosed changes and modifications, those that may not literally fall within the scope of the present claims constitute, therefore, a part of the present invention in the sense of a doctrine of equivalents.

The use of the articles “a,” “an,” and “the,” and similar referents in the specification and claims, are to be construed to cover both the singular and the plural, unless otherwise indicated herein or clearly contradicted by the context. The use of any and all examples, or exemplary language (e.g., “such as”) provided herein, is intended merely to better illuminate the invention and does not pose a limitation on the scope of the invention unless otherwise claimed.

### BRIEF DESCRIPTIONS OF THE DRAWINGS

FIG. 1 shows an external view of one example of the automatic pouring equipment to which the method of the present invention is applied.

FIG. 2 is a vertical cross-sectional view of the ladle of the automatic pouring equipment of FIG. 1.

FIG. 3 is an enlarged view of the main part of FIG. 2.

FIG. 4 is a perspective view of the end of the outflow position of the ladle.

FIG. 5 is a block diagram showing a process of pouring in the automatic pouring.

FIG. 6 are graphs of the relationship of the horizontal area on the outflow position, A (m²), to the angle of the tilting of the ladle 1, θ (degrees), and the volume of the molten metal below the outflow position, Vs (m³), to the angle of the tilting of the ladle 1, θ (degree).

FIG. 7 are graphs that give the results of the experiment for identifications.

FIG. 8 are graphs that give the results of the experiments for pouring to examine the effectiveness of the model of the present invention, with the initial velocity of pouring being varied.

FIG. 9 is a block diagram of a feed-forward system to control the flow of the molten metal.

FIG. 10 are graphs of the results of the simulations of FIG. 9 when the system to control the flow of the molten metal is applied to the automatic pouring equipment to which the present invention is applied.

FIG. 11 is a graph of the results obtained from the desired flow pattern of the molten metal after the volume of the molten metal is converted to the weight and processed by the load cell model as shown in FIG. 5.

FIG. 12 shows the results of the experiments when the system to control the flow of the molten metal is applied to the automatic pouring equipment of the present invention, provided that the desired pouring pattern of the molten metal is as shown in FIG. 11.

FIG. 13 shows the results of the experiments when the system to control the flow of the molten metal is applied to the automatic pouring equipment of the present invention, provided that the desired pouring pattern of the molten metal is as shown in FIG. 11.

FIG. 14 is a perspective view of the ladle in another example of the embodiment of the automatic pouring equipment of FIG. 1.

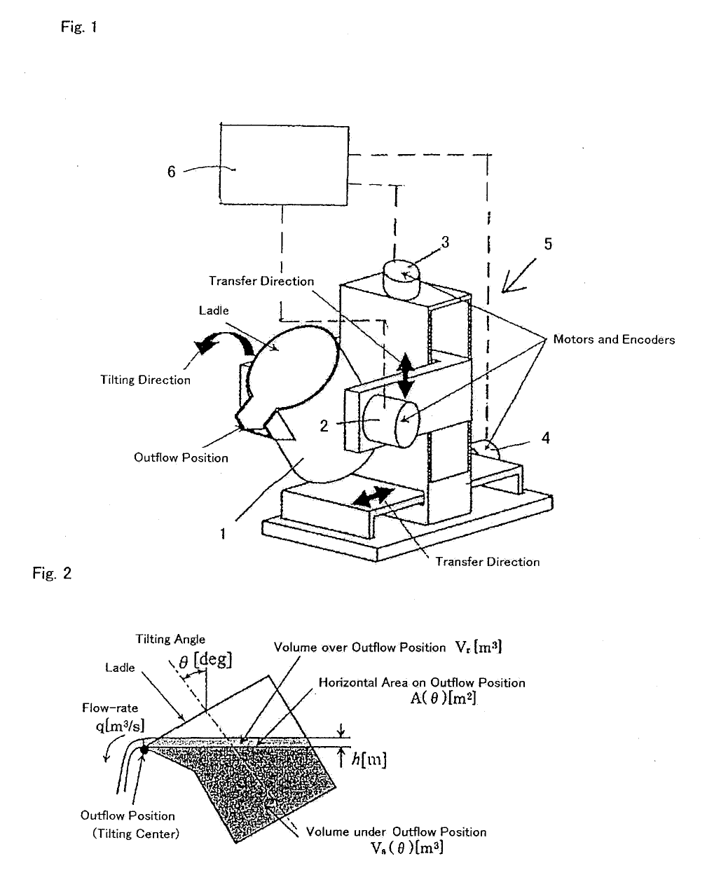

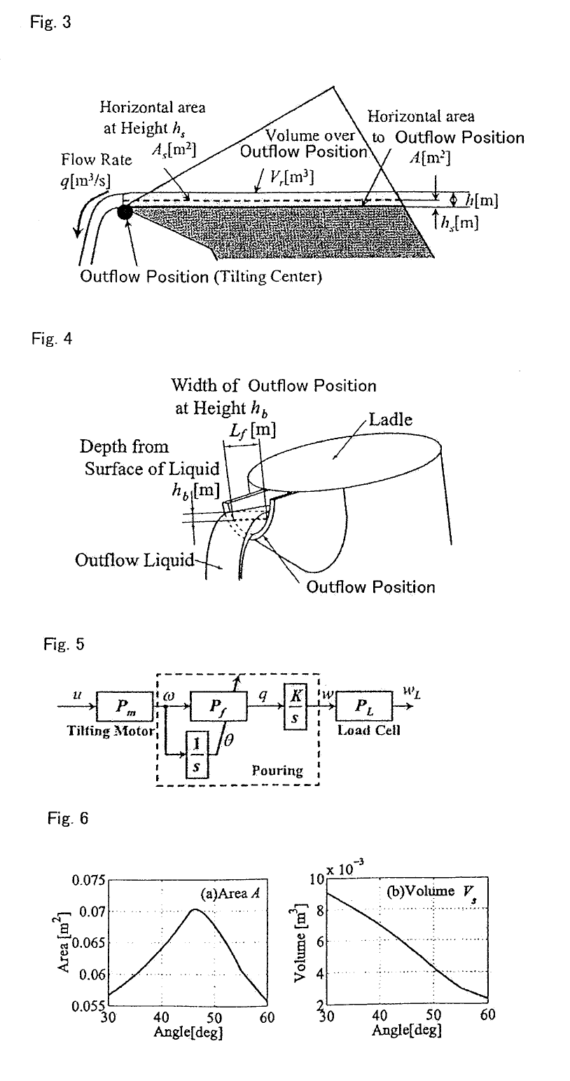

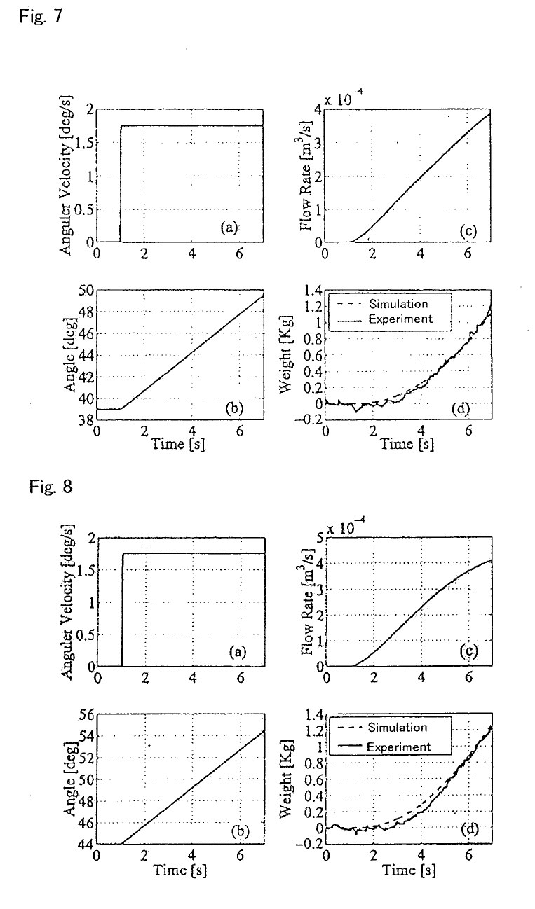

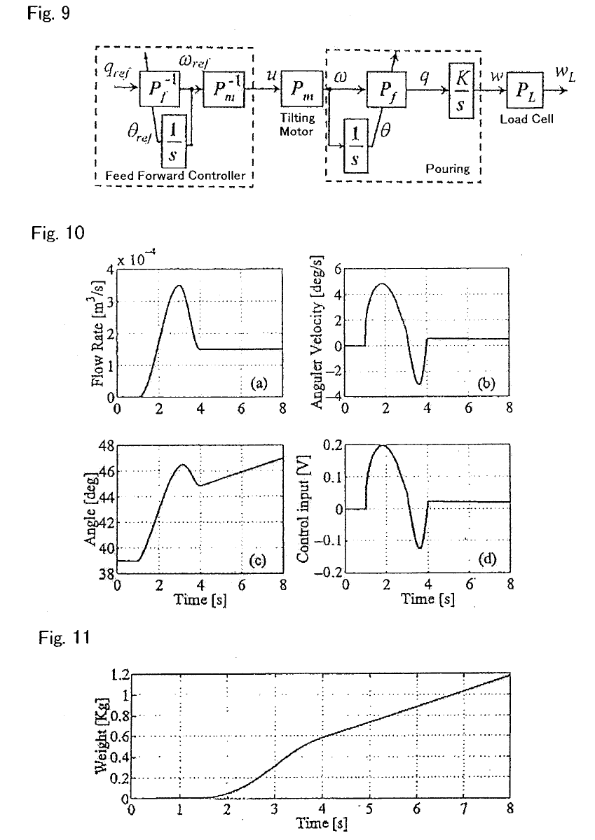

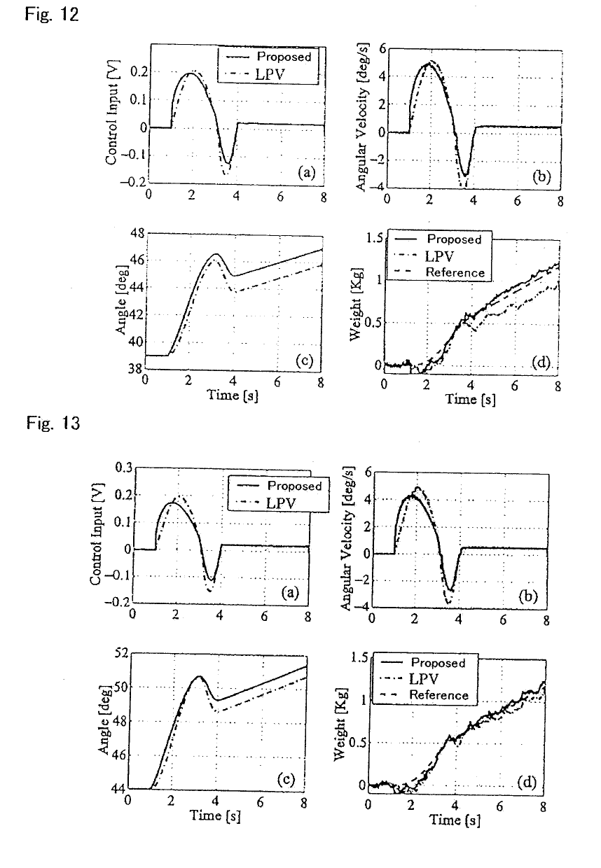

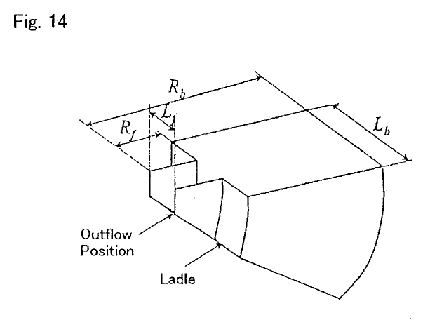

What we claim is:

1. A method to control automatic pouring of molten metal by a ladle comprising controlling a servomotor, corresponding to the desired flow pattern of the molten metal so that the molten metal can be poured into a mold, wherein the servomotor, which tilts the ladle to pour the molten metal in a mold, is controlled by a computer that has programs previously installed that control the process of pouring, characterized in that the method comprises steps of producing a mathematical model covering from an electrical voltage that is supplied to the servomotor through the flow of the molten metal poured by the ladle, then obtaining the electrical voltage to be supplied to the servomotor by solving the inverse problem of the mathematical model thus produced, and controlling the servomotor based on the electrical voltage thus obtained and to be supplied to the servomotor.

2. The method to control the automatic pouring of molten metal by a ladle according to claim 1, comprising:
converting the volume of the molten metal that flows from the ladle calculated by the mathematical model to the weight of the molten metal that flows from the ladle,
comparing the data that are obtained after compensation is made for the dynamic characteristics of a load cell with the data obtained from the measurements by the load cell of the weight of the molten metal that flows from the ladle and adjusting both sets of data so that the data that are obtained after compensation is made for the dynamic characteristics of a load cell become consistent with the data obtained from the measurement by the load cell, and
then, obtaining a coefficient of a flow of the molten metal for the mathematical model.

3. The method of control the automatic pouring of molten metal by a ladle
according to claim 1 or 2, wherein the ladle has a cylindrical shape that has a rectangular-shaped outflow position, or has a shape of a fan in its longitudinal cross section that has a rectangular-shaped outflow position.

4. Media that record programs for controlling the tilting of a ladle comprising:
controlling a servomotor, corresponding to a desired flow pattern of the molten metal, so that molten metal can be poured into a mold wherein the servomotor that tilts the ladle to pour the molten metal in a mold is controlled by a computer that has programs previously installed that control the process of pouring, characterized in that the media that record the programs for controlling the tilting of a ladle comprises producing a mathematical model covering from an electrical voltage that is supplied to the servomotor through the flow of the molten metal poured by the ladle, then obtaining the electrical voltage to be supplied to the servomotor by solving the inverse problem of the mathematical model thus produced, and controlling the servomotor based on the electrical voltage thus obtained and to be supplied to the servomotor.
